(19) United States
(12) Patent Application Publication
(10) Pub. No.: US 2013/0110280 A1
(43) Pub. Date: May 2, 2013

(54) SYSTEM AND METHOD FOR SEPARATING AND ORDER PICKING ARTICLES

(71) Applicant: Michael Folk, Jesewitz (DE)

(72) Inventor: Michael Folk, Jesewitz (DE)

(73) Assignee: Apologistics GmbH, Leipzig (DE)

(21) Appl. No.: 13/581,170

(22) PCT Filed: Feb. 21, 2011
(86) PCT No.: PCT/DE11/75029

§ 371 Date: Dec. 10, 2012

(30) Foreign Application Priority Data
Feb. 24, 2010 (DE) 10 2010 002 317.5

(51) Int. Cl. G06F 17/00

(52) U.S. Cl. CPC G06F 17/00
USPC 700/215; 700/216

(57) ABSTRACT

A system for separating and order picking articles, in particular pharmacy articles. The system includes a first transportation system for receiving and transporting delivered articles; a second transportation system for receiving and transporting separated articles; a first detection system for detecting at least the position of the articles on the first transportation system; a handling device for separately taking articles from the first transportation system and their transfer onto the second transportation system; a second detection system for the identification of the articles; a deposition zone downstream the second detection system for interim storing an article; and a data processing system.

The invention relates to a system for separating and order picking articles as well as a method suitable for that.

A method for storing pharmacy articles is known from DE 43 18 341 B4 wherein articles having rectangular packages are poured from a packing drum onto a band conveyor and thus fed to a detection system. The detection system includes four scanners that should be arranged such that the bar codes disposed at the narrow sides, the bottom, or the lid of the package can be detected. The detection systems are connected to a computer unit wherein a database for storing the detected bar codes is installed. In order for the scanners to be able to detect the bar code transparent faces are provided in the band conveyor and at its edge regions. If one of the packages is in an unfavorable position, then it is sorted out by means of a sorting out device, for example a mechanically operated rejection flap or a compressed air nozzle, and conveyed back to the start of the band conveyor via a returning device. Thus, the article again passes the same procedure in the hope that this time it lies in the correct position on the band conveyor that enables the identification by means of the scanner. When the article is detected it reaches a measuring device with the help of which the outer dimensions of the article are determined. Subsequently, the article is stored in a drawer by means of a gantry robot.

Thus, the method known from the prior art requires an identification of the article before a separation can be done. If the identification is not successful the article must be sorted out. This requires a sorting out device and a returning device. With that, the separation of the articles as a whole is associated with a high technical effort.

DE 10 2007 077 411 A1 discloses a method and a device for storing medical drug packages. The packages that are in drawers in a drawer shelf shall be separated and subsequently identified with the help of their designation. Packages which cannot be identified are sorted out after an identification attempt or thrown back into the starting container.

DE 10 2007 038 837 A1 is directed to a method and a device for moving general cargo that shall be useful for the separation of parcels. Unidentified articles are deposited at a given position (pallet at deposition position E). Then, the articles deposited there should be resorted “manually or by an additional robot”.

Object of the invention is to eliminate the disadvantages of the prior art. In particular, there is provided a system for separating and order picking articles that enables reliable identification and thus prevents sorting out and returning the article. Furthermore, there is provided a method that enables the separation and order picking, in particular with said system.

The object is solved by the features of claims 1 and 7. Practical embodiments of the inventions result from the features of claims 2 to 6 as well as 8 to 11.

According to the invention a system for separating and order picking articles, in particular pharmacy articles is provided, comprising
a first transportation system for receiving and transporting delivered articles;
a second transportation system for receiving and transporting separated articles;
a first detection system for detecting at least the position of the articles on the first transportation system;
a handling device for separately taking articles from the first transportation system and their transfer onto the second transportation system;
a second detection system for the identification of the articles;
a deposition zone downstream the second detection system for interim storing an article not identified by the second detection system and its position change relative to its position in the handling device; and
a data processing system for processing the data detected by the first and second detection systems and for controlling the handling device;
   wherein the second detection system is downstream the first detection system and wherein the second detection system is disposed between the first and second transportation systems and is directed to a point of the pathway that is covered by an article taken by the handling device from the first transportation system upon its transfer to the second transportation system.

Further, according the invention a method for separating and order picking articles, in particular pharmacy articles, is provided comprising the following steps:
(a) detecting at least the position of delivered articles that are on a first trans-portation system;
(b) taking up an article detected in step (a) from the transportation system by means of a handling device;
(c) passing the article taken in step (b) by the handling device to a second detection system;
(d) identification of the article by the second detection system or, if the identification is not successful, depositing the article onto a deposition zone downstream the second detection system and re-uptake of the article by means of the handling device from the deposition zone while changing the position of the article relative to its position in the handling device and repeating steps (c) and (d) until the identification of the article; and
(e) depositing the identified article onto a second transportation system.

The system and method according to the invention are characterized in that the article taken up by the handling device from the first transportation system is no longer returned to this transportation system, especially not when the taken article cannot be identified. If at first an article cannot be identified by the second detection system the article is deposited in the deposition zone that is preferably directly adjoining the second detection system. The handling device takes up the deposited article from there such that the article has a changed position with respect to the handling device. If, for example, the bar code on the article is hidden by a part of the handling device, for example a gripper, so depositing the article on the deposition zone and the re-uptake of the article in a changed position enable exposure of the bar code so that, after this intermediate step, the article can now be fed again to the second detection system for identification. Should the identification even not be possible, depositing on the deposition zone and the re-uptake with a changed position can be repeated. The step of depositing an unidentified article on the deposition zone and its uptake from the deposition zone in a changed position is done n times wherein n is a given integer greater than 0 and is for example 1, 2, or 3. If the article can still not be identified it is sorted out, for example by depositing it on a sorting out zone. There, the storekeeper can decide about the further treatment of the unidentified article. Such a sorting out may for example be required if the bar code applied to the article is damaged.

The system according to the invention and the method according to the invention are in particular suitable for the separation of articles of different types such as for example of pharmacy articles but can also be used for the separation of other articles. One advantage of the invention is that the separation can be used for order picking delivered articles of different types differing in their identity, their outer shape, their weight, and/or other features. By using the system according to the invention and the method according to the invention the separation of delivered articles of different types can be done in an automated manner, i.e. without human interventions wherein in contrast to the prior art a relatively low mechanical effort is required.

Preferably, the first detection system is an optoelectronic detection system directed to the first transportation system. For example, the first detection system may be a camera such as a CCD camera continuously or discontinuously taking pictures of the delivered articles on the transportation system.

Preferably, the first detection system not only detects the position of the delivered articles on the first transportation system, but additionally also further features of the article. These features of the article are for example the outer shape of the article e.g., cylindrical, spherical, rectangular, or pyramid-shaped; members of the outer shape of the article, e.g. a circular, triangular, four-sided surface; a classification of the article according to its weight, size, or material, e.g. solid package made of cardboard or package having a variable shape such as bags, for example teabags or bath salt bags; as well as combinations of one of these features with one or more further of these features.

These features of the article as well as its position on the first transportation system are calculated by means of a software from the data, in case of a camera from the pictures, that are transferred from the first detection system to the data processing system. Based on the data obtained the classification of the articles into given groups, for example with respect to the feature size into a class with a size below a given threshold value (class small) and a class with a size at or above the given threshold value (class big) can be done. From the established data it can also be inferred to the weight of the article so that a classification of the article according to the weight of the article, e.g. into a group with a weight below a given threshold value (class light) or a group with a weight at or above a given threshold value (class heavy) can be done. Such a classification according to the weight can be obtained for example on the basis of the data relating to the outer dimensions of the article as well as the data about the outer material of the article. For example, with pharmacy articles it is possible to establish from the pictures taken by the first detection system by means of a software whether these are glass bottles, i.e. an article having a high weight, or tablet boxes of the package size N1 according to the package size regulation, i.e. an article having a small weight.

Preferably, the taken pictures are analyzed by a picture-processing software stored in the data processing device. The picture-processing software together with the first detection system forms a picture-processing system. This picture-processing system can for example use a light-slit method that is based on the principle of the metrological triangulation method known per se. With the triangulation method the position coordinates of the articles and thus their positions can be mathematically calculated. In this way, the articles can be detected in any found manner. A feed in a container required according to the prior art is no longer necessary.

The data that are transmitted by the first detection system to the data processing system are not used for the identification of the article.

After the position and, if given, further features of an article lying on the first trans-portation system has been established in the data processing system the data processing system generates control signals for the handling device and transmits these to the handling device. With that, the handling device is caused to take the article from the first transportation system and pass it to the second detection system.

Preferably, the handling device is a robot, for example a robot having an articulated arm or a pivoted arm. Preferably, the robot is a robot having a plurality of axes of motion. The robot should have at least one gripping or suction device for taking up the article from the first transportation system. Preferably, the robot has a plurality of gripping or suction devices wherein each of these gripping or suction devices is adapted to take up articles having given features. These features are features obtained from the pictures taken by the first detection system. Thus, based on these features a gripping or suction device of the handling device can be chosen that is specifically adapted to the article to be taken up.

The second detection system should identify the article taken up by the handling device. For that, identification information applied to the article, for example the bar code, can be used. In pharmacy articles, for example the Pharmacy Product Number (PPN) that can be present as bar code can be used for the identification. Preferably, the second detection system is a scanner such as a bar code scanner. The second detection system should detect these identification information and transmit them to the data processing system. In the data processing system the identification information detected by the second detection system are compared to a database stored there. When the article has been identified on the basis of the identification information, in the case of pharmacy articles as preparation of a particular manufacturer in a certain package size, the article is deposited by the handling device on the second transportation system, preferably at a location given by the data processing system. For that, the data processing system preferably calculates the location of the identified article on the second transportation system and generates control signals for the handling device and transmits them to the handling device so that the handling device is caused to deposit the identified article at the given location on the second transportation system. With that, the separation of the articles is completed.

If the second detection system cannot detect the identification information then, for example an information such as “detection of the bar code not possible” or a code for that can be transmitted to the data processing system. Here, also this information is referred to as identification information.

In case the article cannot be identified on the basis of the identification information transmitted by the second detection system to the data processing system, because for example the bar code applied to the article is completely or partially covered by the gripping or suction device of the handling device, control signals for the handling device can be generated by the data processing system and transmitted to the handling device. After that, the handling device deposits the unidentified article onto the deposition zone downstream the second detection system and takes it up again, preferably immediately after deposition. Here, the article is taken up by the handling device in a slightly changed position so that the identification information now should no longer be covered by the gripping or suction device of the handling device. The term “changed position of the article with respect to the handling position” in the present invention should be understood such that the contact point(s) between the article and the gripping or suction device of the handling device before deposition on the deposition zone differ from the contact points between this article and the gripping or suction device of the handling device after re-uptake from the deposition zone. For example, this can be achieved by turning the article on the deposition zone. This turn can be effected by means of the handling device, for example a rotation of the gripping or suction device along with a rotational axis of the gripping or suction device. After the re-uptake of the article it is passed back to the second detection system in order to get new identification information.

Preferably, the first transportation system is a belt conveyor. Preferably, also the second transportation system is a belt conveyor.

It may be of advantage, if the delivered articles are in upwardly open containers, for example trays that are transported on the first transportation system. In such a tray there are typically a number of different articles, for example pharmacy articles. A number of trays filled with articles in any compilation are transported on the belt conveyor to the first detection system. The first detection system, for example a CCD camera, is fixed above the belt conveyors, for example on the ceiling, and directed to the open upper surface of the trays.

Also at the locations of the identified articles there can be provided upwardly open containers, for example trays that are on the second transportation system, for example a belt conveyor. Then, the identified articles are deposited in trays predetermined by the data processing system by the handling device whereby the separation is completed. By means of the second transportation system the trays can be carried to the next workstation of the logistics, for example a storehouse or the forwarding department.

The data processing system in a conventional manner is connected to the remaining components of the systems, for example via cables or wireless communication means. In one embodiment of the invention the data processing system is characterized in that
(i) the first detection system in step (a) takes pictures of the delivered articles and sends them to the data processing system;
(ii) a computer program stored in the data processing system determines at least the position of the delivered articles;
(iii) the data processing system generates control signals for the handling device and sends them to the handling device;
(iv) the handling device takes up an article due to these control signals from the first transportation system and carries it to the second detection system;
(v) the second detection system detects identification information of the article and sends them to the data processing system;
(vi) in the data processing system the identification information detected by the second detection system are compared to a database and, if the article cannot be identified, control signals for the handling device are generated by the data processing system and send to the handling device so that the handling device is caused to deposit the article onto the deposition zone downstream the second detection system, to re-uptake the article from the deposition zone while changing the position of the article relative to its position in the handling device, and to carry the article to the second detection system again as well as repeat the steps (v) and (vi) until the article has been identified.

Preferably, the data processing system further calculates the location of the identified article on the second transportation system and generates control signals for the handling device and sends them to the handling device so that the handling device is caused to deposit the identified article at the predetermined location on the second transportation system.

Preferably, the data processing system also controls the first and/or second transportation systems, for example the shuttling head of the belt conveyors.

In the following the invention is explained in more detail with reference to examples not intended to limit the invention referring to the drawings. Here,

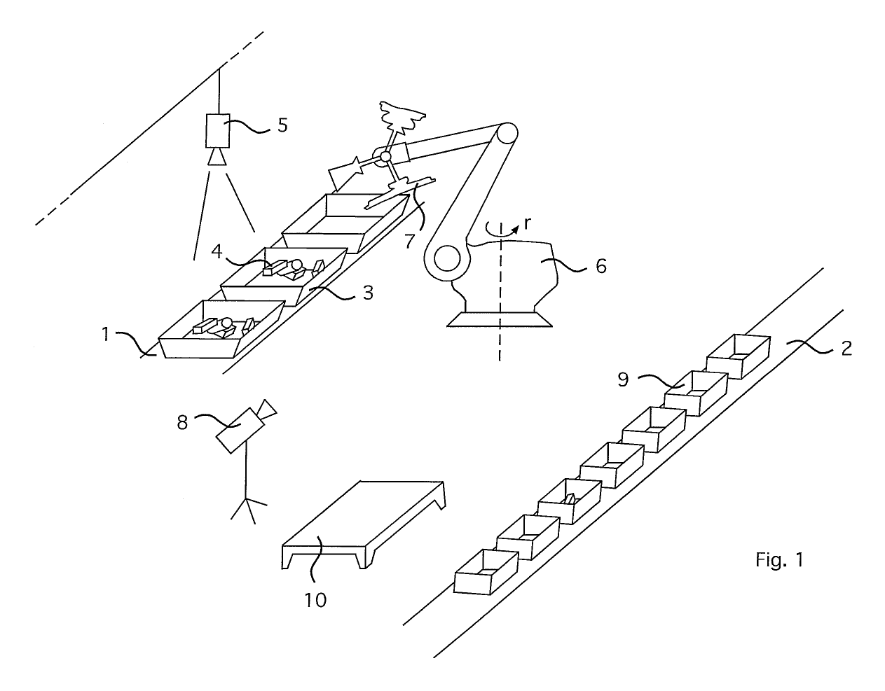

FIG. 1 shows a schematic perspective view of an embodiment of the system according to the invention; and

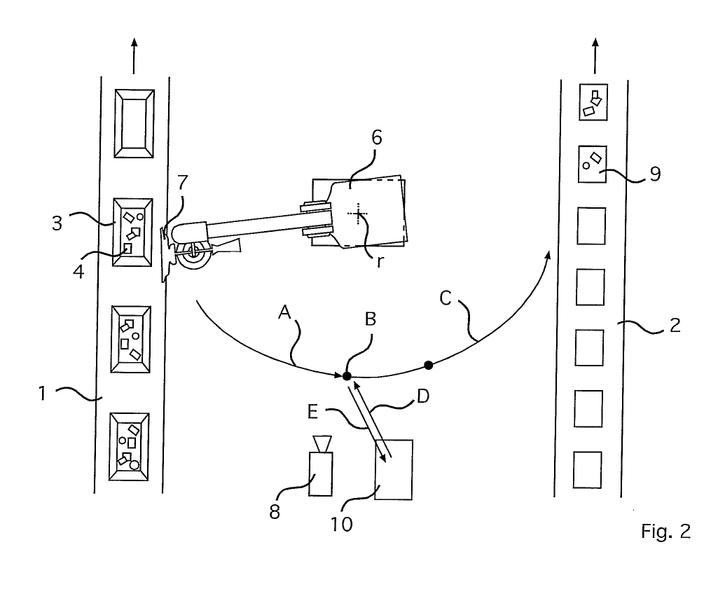

FIG. 2 shows a schematic plan view to the embodiment of the system according to the invention shown in FIG. 1.

The embodiment shown in FIGS. 1 and 2 of the system according to the invention has a first transportation system 1 in the form of a first belt conveyor and a second transportation system 2 in the form of a second belt conveyor. On the first belt conveyor 1 there are first trays 3. In these trays 3 the delivered articles 4 are filled wherein the trays can be filled with a number of different articles differing in their features such as identity, size, weight, and others. Thus, the trays are filled with the delivered articles 4 of different types.

On the first belt conveyor 1 the trays 3 with the delivered articles 4 are carried to the first detection system 5. In the embodiment shown, detection system 5 is a CCD camera disposed above the first belt conveyor 1 and directed vertically downward to the first belt conveyor. Here, camera 5 is designed such that it can completely detect the interior of a tray 3 visible from above. (For simplicity of illustration, detection system 5 is not shown in FIG. 2). CCD camera 5 continuously takes pictures of the articles 4 in the trays 3. The pictures are sent to the data processing system (not shown). The data processing system processes the pictures by means of a software and thus determines from the pictures the position of the articles 4 in the tray 3. Furthermore, by means of the software additional features of each article 4 are determined, for example the outer shape of the article 4, its size, and its package material. Based on the information a classification of the article 4 in the tray 3 is carried out. If, for example, the article 4 is cough syrup in a glass bottle, then article 4 is sorted into the classes “heavy” and “cylindrical”. The identity of article 4 is not calculated from the pictures since due to the position of article 4 in the tray 3 the required identification information cannot be detected by camera 5. Based on the features and the classification results a gripping device 7 of the handling device 6 is chosen which is suitable for taking up the article 4 from the tray 3. In this embodiment of the invention handling device 6 is an articulated arm robot having several grippers 7 each of which is designed for specific gripping functions. Robot 6 is rotatable around a vertical axis r.

The data processing system generates control signals for the robot 6 and sends the control signals to it. By means of the grippers 7 predetermined by the data processing system the robot 6 takes an article 4 also predetermined by the data processing system out of the tray 3. The article 4 is conveyed by the robot 6 along path A to point B that lies on this path. The second detection system 8 which is arranged between the first and second belt conveyors 1, 2 is directed to point B. In this embodiment, the second detection system 8 is a bar code scanner. By means of the bar code scanner the identification of the taken article at point A should be done.

The bar code scanner 8 detects the bar code applied to article 4 and sends it to the data processing system. If the bar code scanner 8 cannot detect the bar code, for example, because the bar code is covered by the gripper or because the bar code is damaged, the information “detection of the bar code not possible” or a code for that is sent to the data processing system. This is also an identification information, although this information does not suffice to identify article 4.

The identification information is sent to the data processing system. In the data processing system the bar code detected by the bar code scanner is compared to the database of bar codes stored there wherein each bar code is assigned to a certain article. If article 4 has been identified based on the identification information, article 4 is trans-ported by the robot 6 along path C to a second tray 9 and deposited in this tray 9.

Tray 9 is on the second belt conveyor 2. Tray 9 wherein the identified article is to be deposited is given by the data processing system and the corresponding control signals are sent by the data processing system to the robot 6. The location, i.e. tray 9, and the identity of the article 4 located there are stored in the data processing system.

So the method can start again, that is, as described another article 4 can be taken up by the robot 6 from tray 3, identified and deposited into a given tray 9.

If the identification information sent by the bar code scanner 8 to the data processing system do not suffice to identify article 4 at point B, because for example the bar code is covered by the gripper or the bar code is damaged, so control signals for the robot 6 that cause a deposition of the unidentified article 4 onto the deposition zone 10 are generated by the data processing system and sent to it. With that, the article covers path D. For example, deposition zone 10 may be a table or a tray. Immediately after article 4 has been deposited on deposition zone 10 the robot 6 takes up the justdeposited article 4 again, however in a slightly changed position so that now the identification information should no longer be covered by the gripping or suction device of the handling device. This is for example achieved by the article being taken up by the robot again in an turned position, for example by firstly turn the article by means of a gripper which can be another gripper 7 than the gripper before the deposition of the article onto the deposition zone 10 (but not has to) by a rotation of the gripping or suction device along a rotational axis. Subsequently, the article 4 is taken up by the robot via a gripper 7 again. Also this gripper 7 can be another gripper 7 than the gripper before the deposition of the article on the deposition zone 10, however, this is not mandatory. After the re-uptake of article 4 it is passed back again on path E to point B. There, the bar code scanner again tries to get identification information. If the identification of article 4 is successful, because for example the initially covered bar code now lies exposed the article is transported along path C to a predetermined tray 9 and deposited there, as described above. If again the identification is not successful, so the article 4 can be deposited onto the deposition zone 10 for a second time, for example turned there, and taken up again. Then, it is conveyed again to point B to detect identification information. If also this time article 4 cannot be successfully identified, because for example the bar code is damaged so article 4 is sorted out wherein for that, it can be for example transported along path C to a predetermined tray 9 specifically being intended for unidentified articles 4. As soon as article 4 has been deposited in a tray 9 the robot can take up another article from a tray 3, by which the method is repeated.

### LIST OF REFERENCE NUMBERS

1 first belt conveyor
2 second belt conveyor
3 first tray
4 article
5 camera
6 robot
7 gripper
8 bar code scanner
9 second tray
10 deposition zone

1. A system for separating and order picking articles, in particular pharmacy articles, comprising:
a first transportation system for receiving and transporting delivered articles;
a second transportation system for receiving and transporting separated articles;
a first detection system for detecting at least the position of the articles on the first transportation system;
a handling device for separately taking articles from the first transportation system and their transfer onto the second transportation system;
a second detection system for the identification of the articles;
a deposition zone downstream the second detection system for interim storing an article not identified by the second detection system and its position change relative to its position in the handling device; and
a data processing system for processing the data detected by the first and second detection systems and for controlling the handling device;
wherein the second detection system is downstream the first detection system and wherein the second detection system is disposed between the first and second transportation systems and is directed to a point of the pathway that is covered by an article taken by the handling device from the first transportation system upon its transfer to the second transportation system.

2. The system according to claim 1,
wherein the first detection system is an optoelectronic detection system directed to the first transportation system.

3. The system according to claim 1,
wherein the second detection system is a bar code scanner.

4. The system according to claim 1,
wherein the handling device has at least one gripping or suction device.

5. The system according to claim 1,
wherein the handling device has several gripping and suction devices, wherein for taking an article from the first transportation system one of these gripping and suction devices can be chosen on the basis of the data detected by the first detection system.

6. The system according to claim 1,
wherein the handling device is a robot having several axes of motion.

7. A method for separating and order picking articles, in particular pharmacy articles, comprising:
(a) detecting at least the position of delivered articles) that are on a first transportation system;
(b) taking up an article detected in step from the transportation system by means of a handling device;
(c) passing the article taken in step by the handling device to a second detection system;
(d) identification of the article by the second detection system or, if the identification is not successful, depositing the article onto a deposition zone downstream the second detection system and re-uptake of the article by means of the handling device from the deposition zone while changing the position of the article relative to its position in the handling device and repeating steps and until the identification of the article; and
(e) depositing the identified article onto a second transportation system.

8. The method according to claim 7,
wherein in step (a) in addition to the position of the delivered articles also their dimensions are determined and in case of a handling device having several gripping and suction devices one of these gripping and suction devices is chosen on the basis of the determined dimension of the article.

9. The method according to claim 7,
wherein in step (a) the delivered articles are in upwardly open containers that are transported on the first transportation system to the first detection system to detect at least the position of the delivered articles in the containers; and that in step the separated articles are deposited in upwardly open containers that are located on the second transportation system.

10. The method according to claim 7,
wherein a data processing system is provided, wherein
the first detection system in step (a) takes pictures of the delivered articles and sends them to the data processing system;
a computer program stored in the data processing system determines at least the position of the delivered articles;
the data processing system generates control signals for the handling device and sends them to the handling device;
the handling device takes up an article due to these control signals from the first transportation system and carries it to the second detection system;
the second detection system detects identification information of the article and sends them to the data processing system;
in the data processing system the identification information detected by the second detection system are compared to a database and, if the article cannot be identified, control signals for the handling device are generated by the data processing system and send to the handling device so that the handling device is caused to deposit the article onto the deposition zone downstream the second detection system, to re-uptake the article from the deposition zone while changing the position of the article relative to its position in the handling device, and to carry the article to the second detection system again as well as repeat the steps (v) and (vi) until the article has been identified.

11. The method according to claim 10,
wherein the data processing system further calculates the location of the identified article on the second transportation system and generates control signals for the handling device and sends them to the handling device so that the handling device is caused to deposit the identified article at the predetermined location on the second transportation system.

12. The system according to claim 2, wherein the second detection system is a bar code scanner.

13. The method according to claim 8, wherein in step the delivered articles are in upwardly open containers that are transported on the first transportation system to the first detection system to detect at least the position of the delivered articles in the containers; and that in step the separated articles are deposited in upwardly open containers that are located on the second transportation system.

14. The method according to claim 8, wherein a data processing system is provided, wherein the first detection system in step (a) takes pictures of the delivered articles and sends them to the data processing system;
a computer program stored in the data processing system determines at least the position of the delivered articles;
the data processing system generates control signals for the handling device and sends them to the handling device;
the handling device takes up an article due to these control signals from the first transportation system and carries it to the second detection system;
the second detection system detects identification information of the article and sends them to the data processing system;
in the data processing system the identification information detected by the second detection system are compared to a database and, if the article cannot be identified, control signals for the handling device are generated by the data processing system and send to the handling device so that the handling device is caused to deposit the article onto the deposition zone downstream the second detection system, to re-uptake the article from the deposition zone while changing the position of the article relative to its position in the handling device, and to carry the article to the second detection system again as well as repeat the steps (v) and (vi) until the article has been identified.

15. The method according to claim 9, wherein a data processing system is provided, wherein the first detection system in step (a) takes pictures of the delivered articles and sends them to the data processing system;
a computer program stored in the data processing system determines at least the position of the delivered articles;
the data processing system generates control signals for the handling device and sends them to the handling device;
the handling device takes up an article due to these control signals from the first transportation system and carries it to the second detection system;
the second detection system detects identification information of the article and sends them to the data processing system;
in the data processing system the identification information detected by the second detection system are compared to a database and, if the article cannot be identified, control signals for the handling device are generated by the data processing system and send to the handling device so that the handling device is caused to deposit the article onto the deposition zone downstream the second detection system, to re-uptake the article from the deposition zone while changing the position of the article relative to its position in the handling device, and to carry the article to the second detection system again as well as repeat the steps (v) and (vi) until the article has been identified.
